(19) United States
(12) Patent Application Publication
(10) Pub. No.: US 2003/0231172 A1
(43) Pub. Date: Dec. 18, 2003

(54) Liquid crystal display device

(75) Inventors: Masaki Kitaoka, Fukushima-ken (JP); Jun Goto, Fukushima-ken (JP)

Correspondence Address: Otto O. Lee, Intellectual Property Law Group LLP, Suite 1205, 12 South First St., San Jose, CA, 95113, US

(73) Assignee: NANOX CORPORATION

(21) Appl. No.: 10/446,953

(22) Filed: May 27, 2003

(30) Foreign Application Priority Data
May 30, 2002 (JP) 2002-157618

(51) Int. Cl. G09G 5/00

(52) U.S. Cl. 345/211

(57) ABSTRACT

The embodiment of the present invention provides a liquid crystal display element using cholesteric liquid crystals having a slight change in electrooptic properties even if the liquid crystals deteriorate by irradiation of light such as ultraviolet rays, etc., and a method for driving the same. An embodiment of the present invention further provides a liquid crystal display device in which pixel spaces are formed, in a matrix form, of a plurality of common electrodes and a plurality of segment electrodes, which are orthogonal to each other, and cholesteric liquid crystals and chiral nematic liquid crystals intervene in the pixel spaces. Further, images may be displayed by applying pulse drive voltage whose frequency is 200 Hz or more between electrodes between which the pixel spaces are placed, and in which the drive voltage applied to the pixels is determined to be (1) the pulse voltage whose frequency is 200 Hz or more, or (2) the first pulse and the second pulse voltage continued therefrom, whose frequency is larger than that of the first pulse voltage.

### BACKGROUND OF THE INVENTION

1. Technical Field of the Invention

The present invention relates to a liquid crystal display device provided with liquid crystal elements, and in particular to a driving method for varying a state of liquid crystal by pulse voltage inputted into electrodes with cholesteric liquid crystals placed between two substrates having matrix-like electrodes on the surface thereof, and carrying for display, and a construction of a liquid crystal display element suitable for the driving method.

2. Prior Art

A liquid crystal display device provided with liquid crystal elements has been known, which displays images by varying a state of liquid crystals with pulse voltage inputted into electrodes in a state where cholesteric liquid crystal or chiral nematic liquid crystal is placed between a common electrode and a segment electrode, respectively, secured on two substrates, and is able to maintain the display in a state where no voltage is applied. The liquid crystal display element carries out display by changing the state of liquid crystal to a planar state or focal conic state.

Japanese Laid-open Patent Publication No. Hei-11-326871 disclosed a driving method operable to rewrite the display of a liquid crystal display element showing a cholesteric phase in a short time. The method is such that, in order to make respective liquid crystals, which are placed between two substrates by applying a pulse voltage between electrodes respectively disposed on the two substrates, into either a planar state or a focal conic state, liquid crystals constituting all the pixels are simultaneously reset in the focal conic state in which selection requires a longer period of time. Thereafter the display state of liquid crystals constituting all the pixels is selected by applying a selection signal to the liquid crystal, which constitutes respective pixels, one after another, and thereafter the display state is maintained by making the voltage, which is applied to the liquid crystals constituting all the pixels, into zero.

Also, in the present specification, a liquid crystal display device (or a liquid crystal module) indicates a combination of liquid crystal display elements and drive IC circuit elements, and further includes a flexible substrate on which electrodes electrically connected for connecting the above-described liquid crystal display elements and drive IC circuit elements to each other is printed.

Since no polarizing plate is used in a liquid crystal display element using cholesteric liquid crystals, which is utilized in a liquid crystal display disclosed by the above-described Japanese Laid-open Patent Publication No. Hei-11-326871, its optical utilization efficiency is high, and a bright display is enabled. However, nothing exists to interrupt ultraviolet rays, making the liquid crystals liable to deteriorate. If liquid crystals sealed in the liquid crystal display device receive irradiation of ultraviolet rays, a part thereof is decomposed, wherein decomposition products including ionized substances are produced. Since the decomposition products are drawn near and moved by electrodes by a low frequency pulse voltage, it is presumed that operations of normal liquid crystals not decomposed, which are due to application of an electric field, are hindered.

In a reflection type liquid crystal display element, it is necessary to select a liquid crystal material whose birefringence An is large, dielectric constant ε is large and viscosity is low, in order to obtain a display element, whose reflectivity is high, having a quick response speed at a low drive voltage. Normally, it is said that such a liquid crystal having high birefringence Δn, high dielectric constant ε and low viscosity is liable to deteriorate due to light since the absorption end of light has a long wavelength. If a liquid crystal optically deteriorates, there arises a critical problem by which electrooptic properties change as the reflection type liquid crystal display element, the contrast thereof is lowered, and the display becomes unclear.

In addition, when sealing an inlet port with an ultraviolet ray hardening resin, etc., after liquid crystal is poured into a liquid crystal cell, the liquid crystal in the vicinity of the inlet port deteriorates due to light such as an ultraviolet ray to be irradiated, and another problem arises, which the part in the vicinity of the inlet port presents an appearance different from that of the other parts.

On the other hand, as have been described in Japanese Laid-open Patent Publication Nos. Sho-59-229547 and Sho-60-54434, an attempt has been made to use a light transmittance type liquid crystal element as an exposure mask. Since a liquid crystal display element using a cholesteric liquid crystal has high light utilization efficiency, since no polarizing plate is used as described above, it is considered that the liquid crystal display element is suitable for such an application. However, in such an application, it is requested that the electrooptic properties scarcely change even if the liquid crystal display element is exposed to ultraviolet rays.

It is therefore an object of the present invention to provide a liquid crystal display element using a cholesteric liquid crystal, in which a change in the electrooptic properties thereof is small even if the liquid crystal deteriorates by irradiation of ultraviolet rays, and a method for driving the same.

### SUMMARY OF THE INVENTION

The above objects can be solved by the following embodiments of the present invention (1) and (2).

(1) An embodiment of the present invention as set forth in claim 1 is a liquid crystal display device for displaying images, which is comprised with pixel spaces formed, in a matrix form, of a plurality of common electrodes and a plurality of segment electrodes, which are orthogonal to each other, cholesteric liquid crystal and chiral nematic liquid crystal intervened in said pixel spaces, by applying drive voltage between electrodes between which said pixel spaces are placed, a driver which apply a pulse voltage whose frequency is 200 Hz or more to said pixels.

According to the embodiment of the invention as set forth in claim 1, even if liquid crystals deteriorate due to ultraviolet rays, start-up characteristics of the liquid crystals, that is, the relationship between drive voltage and luminous reflectance (Vr-T characteristics) is maintained in a state before irradiation of ultraviolet rays, whereby it is possible to securely vary the texture state of liquid crystals, and stabilized display can be brought about.

An embodiment of the invention as set forth in claim 2 is the liquid crystal display device as set forth in claim 1, wherein the driver applies a pulse voltage whose frequency is 200 Hz or more for two or more cycles.

According to the embodiment of the invention as set forth in claim 2, in addition to the action of the embodiment of the invention according to claim 1, the liquid crystal drive voltage can be further lowered by applying a pulse voltage, whose frequency is 200 Hz or more for two or more cycles, as a drive voltage applied to the above-described pixels, than in a case where the pulse voltage is applied for one cycle.

Also, an embodiment of the invention as set forth in claim 3 is the liquid crystal display device as set forth in claim 1, wherein the driver applies a pulse voltage whose frequency is 333 Hz or more.

According to the embodiment of the invention as set forth in claim 3, in addition to the action of the embodiments of the invention according to claim 1 and 2, a further stabilized drive can be further securely carried out.

An embodiment of the invention as set forth in claim 4 is the liquid crystal display device as set forth in claims 1, wherein the driver applies a pulse voltage whose frequency is 5000 Hz or less.

According to the embodiment of the invention as set forth in claim 4, in addition to the actions described in claim 1, the drive voltage Vp of liquid crystal can be further lowered.

An embodiment of the invention as set forth in claim 5 is the liquid crystal display device as set forth in claim 1, wherein the driver selects and drives said display pixels for 50 milliseconds or less.

According to the embodiment of the invention as set forth in claim 5, display and deletion can be further quickly carried out in addition to the actions described in claim 1.

An embodiment of the invention according to claim 6 is the liquid crystal display device as set forth in claim 1, wherein the driver applies said pulse voltage whose frequency is 333 Hz or more, and has 50 milliseconds or less selection time of said display pixels.

According to the embodiment of the invention as set forth in claim 6, the liquid crystal display device is able to carry out further reliable drive and have light response even upon receipt of UV irradiation in addition to the actions of the embodiment of the invention, which are described in claim 1.

An embodiment of the invention according to claim 7 is the liquid crystal display device as set forth in claim 1, wherein surface resistance of a pair of transparent electrodes constituting said display pixel is 50Ω per square or less.

According to the embodiment of the invention as set forth in claim 7, it is possible to make even smaller a difference in the effective voltage between pixels, which is applied to the pixels in addition to the actions of the invention, which are described in claim 1. Still further, the action is effective where the number of pixels is large and precise display is required.

An embodiment of the invention according to claim 8 is the liquid crystal display device as set forth in claim 1, wherein the driver applies the pulse voltage at 2V or less at maximum in a difference between display pixels.

According to the embodiment of the invention as set forth in claim 8, in addition to the actions of the embodiment of the invention as set forth in claim 1, it is possible to make small the quantity of voltage drop depending on the distance between the pixels and drive power supply and to prevent uneven display from occurring.

(2) An embodiment of the invention according to claim 9 is a liquid crystal display device for displaying images, which comprises pixel spaces formed, in a matrix form, of a plurality of common electrodes and a plurality of segment electrodes, which are orthogonal to each other, cholesteric liquid crystal and chiral nematic liquid crystal intervened in said pixel spaces, by applying drive voltage between electrodes between which said pixel spaces are placed, a driver which applies the first pulse voltage and the second pulse voltage continued therefrom, whose frequency is larger than that of the first pulse voltage to said pixels.

According to the above-described claim 9, even if liquid crystals deteriorate due to ultraviolet rays, start-up characteristics of the liquid crystals, that is, the relationship between drive voltage and reflectivity (Voltage-reflectivity curves) is maintained in a state before irradiation of ultraviolet rays, whereby it is possible to securely vary the texture state of liquid crystals, and a stabilized display state can be brought about.

An embodiment of the invention according to claim 10 is the liquid crystal display device as set forth in claim 9, wherein the driver applies the first and second pulse voltage whose frequencies are f1 and f2 respectively, wherein f1<200 Hz≦f2 is established.

According to the embodiment of the invention as set forth in claim 10, in addition to the action of invention, which is described in claim 9, even if liquid crystals deteriorate due to ultraviolet rays, start-up characteristics of the liquid crystals, that is, the relationship between drive voltage and luminous reflectance (Voltage-reflectivity curves) is further securely maintained in a state before irradiation of ultraviolet rays.

In view of enabling stabilized and secure display with respect to irradiation of ultraviolet rays, it is favorable that the frequency of the above-described second pulse voltage is 200 Hz or more.

Further, if the frequency of the above-described first pulse voltage is less than 200 Hz, the planar voltage Vp is made lower by the corresponding drive pulse component, wherein low-voltage drive can be carried out.

An embodiment of the invention according to claim 11 is the liquid crystal display device as set forth in claim 9, wherein the driver applies said second pulse voltage whose frequency f2 is 5,000 Hz or less.

According to the embodiment of the invention as set forth in claim 11, the drive voltage Vp of liquid crystal can be made even lower. The reason is in that, if the frequency of the second pulse voltage exceeds 5000 Hz, voltage necessary to drive the liquid crystal becomes excessively high, in addition to the actions of the invention, which are described in claim 9.

An embodiment of the invention according to claim 12 is the liquid crystal display device as set forth in claims 9, wherein the driver applies said first voltages whose frequency f1 is 10 Hz or more.

According to the embodiment of the invention as set forth in claim 12, it is possible to prevent the entire application time T of pulse voltage from becoming longer and the speed to change the display from delaying where the frequency of the first pulse is less than 10 Hz, in addition to the actions of the invention, which are described in claim 9.

An embodiment of the invention according to claim 13 is the liquid crystal display device as set forth in claims 9, wherein the driver applies said second pulse voltage whose frequency is 200 Hz or more for two or more cycles.

According to the embodiment of the invention as set forth in claim 13, in addition to the actions of the embodiments of the invention, which are described in claim 9 through claim 12, if the above-described second pulse voltage whose frequency is 200 Hz or more is applied for two or more cycles as a drive voltage applied to the above-described pixels, the liquid crystal drive voltage as defined in any one of claims 9 through 12 can be further lowered.

An embodiment of the invention according to claim 14 is the liquid crystal display device as set forth in claim 9, wherein the driver applies the second pulse voltage 20% or more in the ratio of time for selecting and driving said display pixels.

According to the embodiment of the invention as set forth in claim 14, in addition to the actions of the invention, which are described in claim 9, there is another action by which a change in the voltage-reflectivity curve (V-R characteristics) due to irradiation of ultraviolet rays can be further securely decreased.

An embodiment of the invention according to claim 15 is the liquid crystal display device as set forth in claim 9, wherein the driver applies the second pulse voltage 80% or less in the ratio of time for selecting and driving said display pixels.

According to the embodiment of the invention as set forth in claim 15, in addition to the actions as defined in claim 9, there is another action by which the planar voltage can be further lowered.

An embodiment of the invention according to claim 16 is the liquid crystal display device as set forth in claim 9, wherein the driver selects and drives said display pixels for 50 milliseconds or less.

According to the embodiment of the invention as set forth in claim 16, in addition to the actions of the invention, which are described in claim 9, display and deletion of images can be further quickly carried out.

Generally, display change time of 200 through 1000 milliseconds is required for signboard display and that of 5 through 15 milliseconds is required for an electronic book. If the entire sum of application time of the above-described pulse voltage is made into 50 milliseconds or less, requirements in almost all liquid crystal patterns can be satisfied.

An embodiment of the invention according to claim 17 is the liquid crystal display device as set forth in claim 9, wherein the surface resistance of a pair of transparent electrodes constituting said display pixel is 50Ω per square or less.

According to the embodiment of the invention as set forth in claim 17, in addition to the actions of the embodiment of the invention, which are described in claim 9, it is possible to make smaller a difference in the effective voltage applied to the pixels between the pixels. This action is effective when the number of pixels is large and precise display state is executed.

An embodiment of the invention according to claim 18 is the liquid crystal display device as set forth in claim 9, wherein the driver applies the pulse voltage at 2V or less at maximum in a difference between display pixels.

According to the embodiment of the invention as set forth in claim 18, in addition to the actions of the invention, which are described in claim 9, the quantity of voltage drop depending on the distance between the pixels and drive power supply can be made even smaller, and it is possible to prevent uneven display from occurring.

In the embodiment of the invention, the device has two kinds of drivers which are able to apply pulse electrodes voltage whose frequency are around 100 Hz and pulse electrodes voltage whose frequency are wide range around 50 to 5,000 Hz.

With the embodiment of the present invention, in a liquid crystal display element utilizing cholesteric liquid crystals, there exists a driving method that scarcely influences the electrooptic properties even if the liquid crystals deteriorate, and it has been found that it is necessary to optimize the structure of a liquid crystal panel as described below in order to carry out the driving method.

A planar texture and a focal conic texture exist in nematic liquid crystal textures in which cholesteric liquid crystal and chiral agent are blended by a fixed quantity. Both textures are stabilized after voltage application stops, and the state thereof is maintained. In these liquid crystal display elements, display is carried out by changing these two textures.

In embodiments of the invention, although liquid crystal pixels are formed in an area in which common electrodes and segment electrodes are intercrossed with each other, a component for determining the textures of liquid crystal is a component for determining whether the state of liquid crystal is of a planar texture or a focal conic texture, of pulse signals inputted into liquid crystals corresponding to optional pixels. In actually driving liquid crystal display elements, the liquid crystal display is changed for the first time by inputting the component. Only the remaining components with the above-described component removed of pulse signals inputted into the liquid crystals are not able to change the display.

A liquid crystal display device according to an embodiment of the invention is shown in FIG. 1.

In FIG. 1, the common electrodes of the liquid crystal display element are connected to the output terminal of the common driver circuit, and segment electrodes are connected to the output terminal of the segment driver circuit. Based on data obtained from a controller, pulse voltage is, respectively, applied from the common driver circuit to the common electrodes and from the segment driver circuit to the segment electrodes. A difference between the pulse voltages is applied to the liquid crystal.

In an embodiment of the invention, FIG. 2 shows a sketch of a component (hereinafter called a “selection pulse component” or merely called a “pulse component” where it is considered as a pulse component for selecting the planar texture or focal conic texture) for determining the texture of the liquid crystal of the pulse signals inputted into the liquid crystal.

In order to input such a pulse component into liquid crystals, one example of a voltage waveform applied to the common electrode and segment electrodes is shown in FIG. 3(a).

In order to simplify the voltage waveform, FIG. 3(a) shows a matrix structure consisting of four common electrodes and four segment electrodes. However, in the invention, the number of electrodes is not limited thereto. Since the cholesteric liquid crystal has a memory property, theoretically, there is no limitation in the number of common electrodes and segment electrodes.

As shown in FIG. 3(b), where it is assumed that the number of common electrodes in a display area is n, waveforms inputted into a single common electrode to rewrite a pixel are composed of COM waveform components A of one time and COM waveform components B of (n−1) times. Also, waveforms inputted into a single segment electrode are composed of SEG waveform components A led to the planar texture and SEG waveform components B led to the focal conic texture, wherein the total sum of the number of SEG waveform components A and SEG waveform components B is n. FIG. 3 shows a case of n=4.

When the COM waveform components A of the common electrode are inputted, the pixels on the common electrode are led to the planar texture or focal conic texture. The timing of inputting the COM waveform components A is as shown in FIG. 3(a), and shifts from the first COM electrode (COM1) to the next COM electrode (COM2), subsequently to the following COM electrode (COM3), and continues in order.

Where the second one (SEG2) of the segment electrodes in FIG. 3(a) is taken for instance, the voltage waveform inputted into the segment electrodes becomes a waveform in which SEG waveform component B, SEG waveform component A, SEG waveform component B and SEG waveform component B are disposed in this order where the pixel crossing the COM1 is of a focal conic texture, the pixel crossing COM2 is of a planar texture, the pixel crossing the COM3 is of a focal conic texture, and the pixel crossing the COM4 is of a focal conic texture.

A difference between the pulse voltage applied to the segment electrode and pulse voltage applied to the common electrode is applied to the liquid crystals corresponding to the respective pixels.

For example, voltage waveforms inputted into the pixels of COM2 and SEG2 in FIG. 3(a) are shown in FIG. 4(a), and voltage waveforms inputted into the pixels of COM3 and SEG3 in FIG. 3(a) are shown in FIG. 4(b). Since voltage Vp led to the planar texture and voltage Vf led to the focal conic texture differ by panel constructions of a liquid crystal display element, it is necessary to determine the voltages in advance for the respective panel constructions or respective panels. Section pulse components inputted into liquid crystals are portions shown by bold lines in FIG. 4.

V0, V1, V2, V3, V4 and V5 shown in the COM waveform components A, COM waveform components B, SEG waveform components A and SEG waveform components B are determined on the basis of values of the above-described Vf and Vp.

To simplify the description, a waveform to obtain a pulse signal composed of the first pulse equivalent to one cycle and the second pulse equivalent to one cycle is described in FIG. 3 as a selection pulse component inputted into liquid crystal. However, the invention is not limited thereto. A desired selection pulse component can be obtained by setting the shapes of COM waveform components and SEG waveform components.

The above description is given of a drive using an STN driver presently available on the market. However, where the liquid crystal display element is a reflection type, as described in Japanese Laid-open Patent Publication No. Hei-11-326871, this case does not constitute any problem where the display area of the liquid crystal display element is reset by the focal conic texture in advance before the pulse signal shown in FIG. 3 is applied to the liquid crystal display element.

In addition, where the liquid crystal display element is a light transmittance type, the display area may be reset by the planar texture or focal conic texture in advance.

In recent years, a so-called “dynamic drive” method has been proposed in SID'95 Tech. Digest, XXXVI, 347 (1995) or SID'97 Tech. Digest, XXVII, 899(1997), etc., as the method for driving liquid crystal display elements using cholesteric liquid crystals.

In order to input voltage waveform components intended by the embodiment of the invention into liquid crystals by the dynamic drive, one example of voltage waveforms applied to the common electrodes and segment electrodes is shown in FIG. 5.

In order to simplify the voltage waveform, FIG. 5 shows a matrix structure composed of two common electrodes and two segment electrodes. As in the case of FIG. 3, the invention is not limited thereto. Also, as in the case of FIG. 3, a waveform to obtain a selection pulse component that is composed of the first pulse equivalent to one cycle and the second pulse equivalent to one cycle is described.

Further, a voltage waveform inputted into pixels of COM1 and SEG1 in FIG. 5 is shown in FIG. 6(a), and a voltage waveform inputted into pixels of COM2 and SEG1 is shown in FIG. 6b).

Cholesteric liquid crystal, used in a liquid crystal display element, of the embodiment of the present invention includes nematic liquid crystal having positive dielectric anisotropy and a chiral agent by 10 through 50% by weight. There is no special limitation in the nematic liquid crystal used to produce cholesteric liquid crystals. However, in a reflection type liquid crystal display element, cyanobiphenyl type, cyanoterphenyl type, cyanobiphenylcyclohexane type, and tolan type liquid crystals, which have large reflectivity anisotropy (birefringence) An are favorable in order to obtain a planar texture of reflectivity. Also, in order to obtain a liquid crystal composition having a satisfactory ultraviolet-ray resisting property, the cyanobiphenyl type, cyanoterphenyl type, cyanophenylcyclohexane type and cyanobiphenylcyclohexane type liquid crystals are preferable.

Also, it is preferable that the thickness of a liquid crystal layer is 3 μm or more and 6 μm or less. If the thickness is less than 3 μm, it is difficult to make the thickness of the liquid crystal layer uniform on the entire surface of the display area. Also, in the reflection type display element, since the reflectivity of the planar texture becomes remarkably low if the thickness of the liquid crystal layer is 3 μm or less, it is not preferable. In addition, since the voltage Vp to obtain a planar texture becomes large if the thickness of the liquid crystal layer is 6 μm or more, it is not preferable.

According to the embodiments of the invention of claim 1 through claim 8, as described below, even if liquid crystals deteriorate by irradiation of ultraviolet rays, a liquid crystal display element having a small change in the relationship between the applied voltage and luminous reflectance can be brought about.

Therefore, even if liquid crystals in the vicinity of a liquid crystal inlet deteriorate due to light such as ultraviolet rays to be irradiated when sealing the liquid crystal inlet, a display free from any influence in practical applications is enabled.

Also, even if ultraviolet rays are irradiated during practical applications, a chronological change in the V-R characteristics is slight, wherein secure display is stabilized.

In addition, the present liquid crystal display device can be preferably utilized in uses for exposure masks having a great quantity of light irradiation and an optical shutter for optical molding.

### BRIEF DESCRIPTION OF THE DRAWINGS

FIG. 1 is a constructional view of a liquid crystal display device according to an embodiment of the present invention.

FIG. 2 is a view showing components, to determine the texture of liquid crystals, of pulse signals inputted into a liquid crystal according to embodiments of the present invention.

FIG. 3 is a simplified constructional view describing pulse signals inputted into common electrodes of a liquid crystal display device in FIG. 1 and pulse signals inputted into segment electrodes thereof.

FIG. 4 is a view showing waveforms of voltages between electrodes carrying out display of pixels in display areas in FIG. 3.

FIG. 5 is a simplified constructional view describing pulse signals inputted into common electrodes of a liquid crystal display device in FIG. 1 and pulse signals inputted into segment electrodes thereof.

FIG. 6 is a view showing waveforms of voltages between electrodes carrying out display of pixels in display areas in FIG. 5.

FIG. 7 is a sectional view of a reflection type liquid crystal display element according to embodiments of the present invention.

FIG. 8 is a view showing pulse signals inputted into liquid crystals according to an embodiment 1 of the present invention.

FIG. 9 is a view showing pulse signals inputted into liquid crystals according to embodiment 2 of the present invention.

FIG. 10 is a view showing pulse signals inputted into liquid crystals according to an embodiment of the present invention, Comparative Control 1.

FIG. 11 is a view showing pulse signals inputted into liquid crystals according to an embodiment of the present invention, Comparative Control 2.

FIG. 12 is a view showing the pulse voltage-luminous reflectance characteristics of a liquid crystal display element according to embodiment 1 at 25° C.

FIG. 13 is a view showing the pulse voltage-luminous reflectance characteristics of a liquid crystal display element according to embodiment 2 at 25° C.

FIG. 14 is a view showing the pulse voltage-luminous reflectance characteristics of a liquid crystal display element according to Comparative Control 1 at 25° C.

FIG. 15 is a view showing the pulse voltage-luminous reflectance characteristics of a liquid crystal display element according to Comparative Control 2 at 25° C.;

FIG. 16 is a view showing a pulse signal inputted into liquid crystals in order to investigate the pulse voltage-luminous reflectance characteristics of liquid crystal display elements according to an embodiment 3 of the present invention and Comparative Controls 3 and 4;

FIG. 17 is a view showing the pulse voltage-luminous reflectance characteristics of embodiment 3, and Comparative Controls 3 and 4;

FIG. 18 is a view showing a pulse signal inputted into liquid crystals in order to investigate the pulse voltage-luminous reflectance characteristics of liquid crystal display elements according to embodiments 4, 5, and 6, of the present invention and Comparative Controls 5 and 6;

FIG. 19 is a view showing the pulse voltage-luminous reflectance characteristics at 25° C. before irradiation of ultraviolet rays onto the liquid crystal display elements in FIG. 7 according to the pulse signals of embodiments 4, 5, and 6;

FIG. 20 is a view showing the pulse voltage-luminous reflectance characteristics at 25° C. after irradiation of ultraviolet rays onto the liquid crystal display elements in FIG. 7 according to the pulse signals of Comparative Controls 5 and 6.

FIG. 21 is a view showing the relationship between input pulse frequencies of liquid crystal display elements and V4 (the minimum voltage for making the focal conic texture into the planar texture) with respect to embodiments 7 through 12 of the present invention and Comparative Control 7;

FIG. 22 is a view showing the pulse voltage-luminous reflectance characteristics of the liquid crystal display elements according to embodiments 13, 14 and 15 of the present invention, and Comparative Control 8 after irradiation of ultraviolet rays; and

FIG. 23 is a view showing the pulse voltage-luminous reflectance characteristics of the liquid crystal display elements of FIG. 7 according to an embodiment 16 of the present invention at 25° C. after irradiation of ultraviolet rays.

### DETAILED DESCRIPTION OF SPECIFIC EMBODIMENTS

A description is given of embodiments of the invention with reference to the accompanying drawings.

(Experiment 1)

Embodiments 1A, 1B, and 2, Comparative Controls 1 and 2

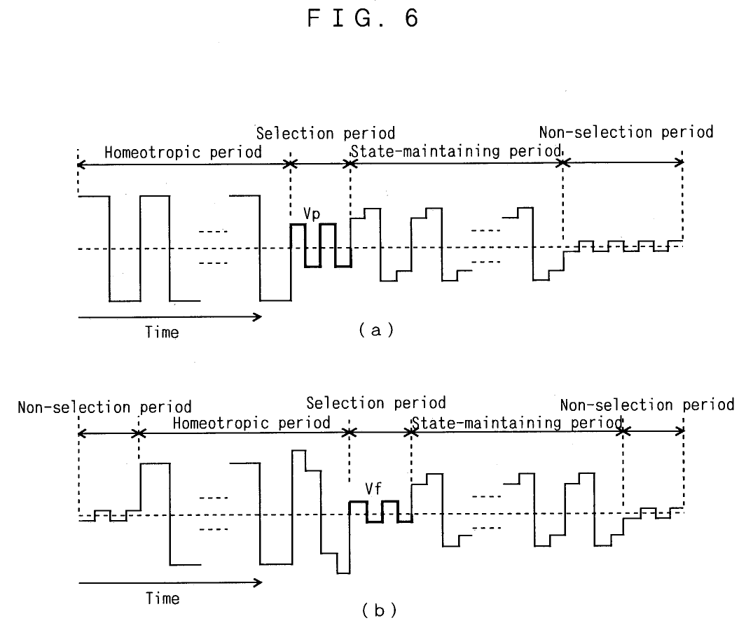

Using cholesteric liquid crystal which is obtained by blending nematic liquid crystal RPD-84202 of 0.7 grams, which is produced by Dainippon Ink and Chemicals, Inc., chiral agent CB-15 at 0.2 grams, which is produced, by Merck Corporation, and chiral agent CNL-617R at 0.1 grams, which is produced by Asahi Denka Co., Ltd., a reflection type liquid crystal display element shown in FIG. 7 was produced. The surface resistance (sheet resistance) of transparent electrode 2 is 30Ω per square for both (common electrodes and segment electrodes), and the common electrodes are patterned to have a width W=500 μm and a length L=150 mm, wherein L/W=300, and the number of pixels is 300×100. The segment electrodes have L/W=100. The thickness of the liquid crystal layer was made into 5 μm.

In FIG. 7, quartz glass, soda lime glass having an alkali ion elution preventing layer such as SiO₂ layer, etc., formed, or a transparent plastic substrate may be listed as transparent substrate 1.

A transparent electrode 2 such as ITO and tin oxide layer, etc., barrier coating (SiO₂ electric insulation layer) 3, and polyimide-based vertical orientation layer 4 are laminated on the transparent substrate 1 in order. The transparent electrode 2 such as ITO and tin oxide layer, etc. is patterned on a plurality of linear electrodes. These two transparent substrates are adhered to each other by main seals 5 so that the electrodes cross each other and the above-described cholesteric liquid crystal 6 is sealed in a space partitioned by the main seals 5. A black printed layer is formed on a single side of the obtained liquid crystal panel as an optical absorption layer 7. The color of the optical absorption layer 7 is not specially limited. However, black or blue is preferable.

For the obtained panel, in an area where end portions (the sides opposite to the terminal portion into which a pulse signal is inputted) of both the electrodes, the pulse voltage-luminous reflectance characteristics are measured before and after irradiation of ultraviolet rays (70 mW/cm², for about ten minutes), influences resulting from a difference in the drive pulse are investigated. The measurement temperature is 25° C.

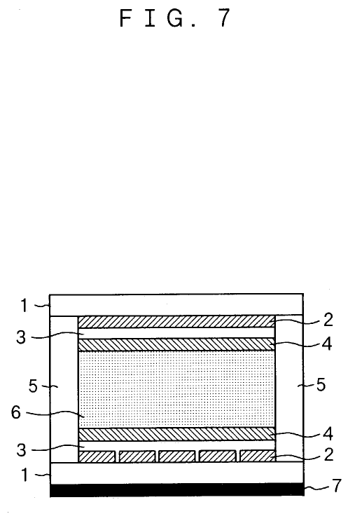

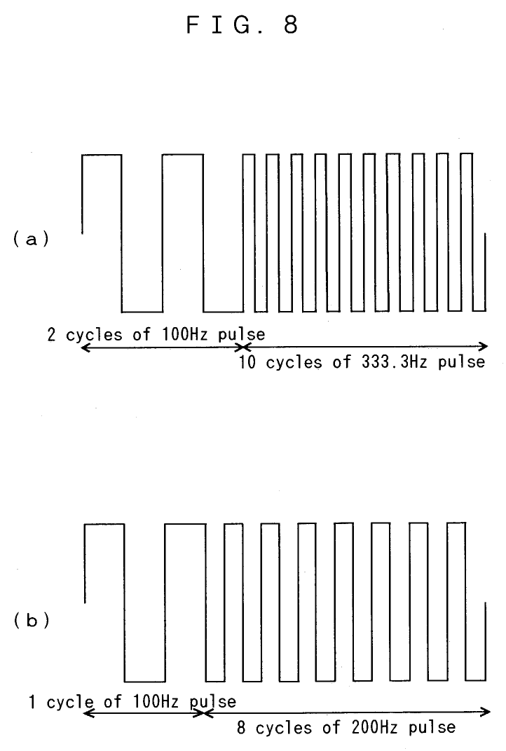

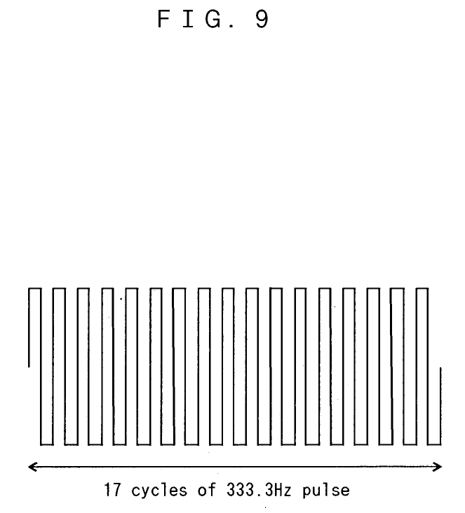

Pulses used for measurement are as shown in FIG. 8 (Embodiment 1A(b), Embodiment 1B(FIG. 8(b)), FIG. 9 (Embodiment 2), FIG. 10 (Comparative Control 1), and FIG. 11 (Comparative Control 2), and the waveforms thereof are assumed to be selection pulse components inputted into liquid crystal with respect to the drive of an actual liquid crystal display device. In the case of Embodiment 1 shown in FIG. 8, pulses of 100 Hz are shunted to two cycles for 20 milliseconds, and pulses of 333.3 Hz are shunted to ten cycles for a further 30 milliseconds. In the case of Embodiment 2 shown in FIG. 9, pulses of 333.3 Hz are shunted to 17 cycles. In the case of Comparative Control 1, pulses of 100 Hz are shunted to five cycles for 50 milliseconds, and in the case of Comparative Control 2, pulses of 333.3 Hz are shunted to ten cycles for 30 milliseconds, and pulses of 100 Hz are shunted to two cycles for a further 20 milliseconds. The pulses of Comparative Control 2 are those obtained by reversing the order of the first pulse and second pulse in Embodiment 1.

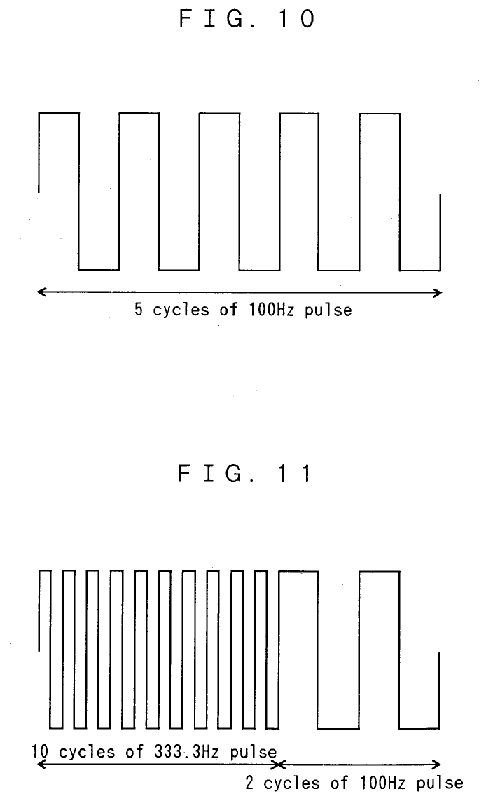

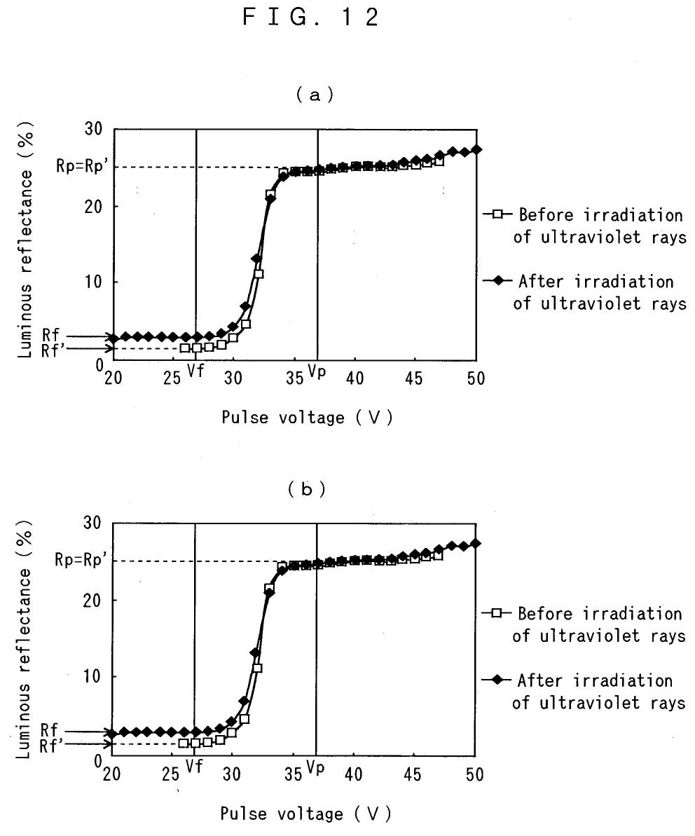

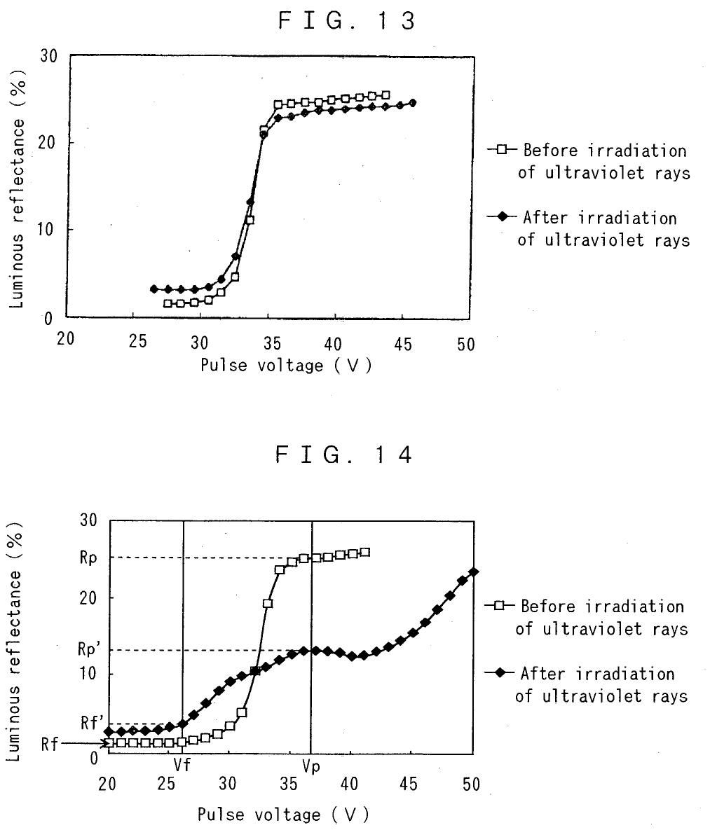

The results of measurement of Embodiments 1A and 1B are, respectively, shown in FIG. 12(a) and FIG. 12(b), and the results of measurement of Embodiment 2 are shown in FIG. 13. The results of Comparative Control 1 are shown in FIG. 14. Also, the results of measurement of Comparative Control 2 are shown in FIG. 15. Either of these shows the pulse voltage-luminous reflectance characteristics when being reset by the focal conic texture.

In FIG. 14, it is assumed that, when driving the liquid crystal display element by pulses shown in FIG. 10, with respect to the initial settings of the drive voltage, the voltage to obtain a planar texture is Vp, and voltage to obtain a focal conic texture is Vf. FIG. 14 shows the pulse voltage-luminous reflectance characteristics when being reset by the focal conic texture. Therefore, in actuality, the voltage Vf becomes a voltage for retaining the focal conic texture. It is assumed that, in the initial (before irradiation of ultraviolet rays), the reflectivity of the planar texture is Rp (27%), the reflectivity of the focal conic texture is Rf (2%), after the irradiation of ultraviolet rays, the reflectivity of the planar texture is Rp′ (12%), and the reflectivity of the focal conic texture Rf′ is (13%). In this case, contrast of the liquid crystal display element is Rp/Rf(27/2/=13.5 times) in the default. However, Rp/Rf is decreased to Rp′/Rf (12/3=4 times) by irradiation of ultraviolet rays, wherein it is found that the display quality is remarkably spoiled by the irradiation of ultraviolet rays.

Similarly, judging from the results in FIG. 15, with the waveform obtained by reversing the first pulse and second pulse, it is found that there is no effect in preventing the display quality from being lowered by irradiation of ultraviolet rays.

On the other hand, in FIG. 12, in a case where pulses of 100 Hz are shunted to two cycles for 20 milliseconds as shown in FIG. 8, and pulses of 333.3 Hz are shunted to ten cycles for a further 30 milliseconds, the reflectivity is Rp=Rp′ (=27%) or Rf≈Rf′ (2 through 3%), wherein a change in the display quality due to irradiation of ultraviolet rays is remarkably small.

In comparison with the results of Embodiment 2, Comparative Controls 1 and 2, where it is assumed that, with respect to the pulses in FIG. 10, pulses for the beginning two cycles are the first pulses, and those for the next three cycles are the second pulses, the frequency of the second pulses are influenced by a change in the display quality due to irradiation of ultraviolet rays.

Further, in FIG. 13, where pulses of 333.3 Hz are shunted to 17 cycles for 50 milliseconds as shown in FIG. 9, the reflectivity is Rp=Rp′ (=2.5%) or Rf≈Rf′ (2 through 3%), wherein a change in the display quality due to irradiation of ultraviolet rays is remarkably small.

In the case of applying a single pulse voltage, it is necessary to apply a pulse voltage of 200 Hz or more on the basis of theses results and those of Embodiment 4 described later. It is found that, where pulse voltages of two types of frequencies are applied, it is necessary to apply a voltage of 200 Hz or more as at least the second pulse voltage.

That is, the relationship between the pulse voltage and the luminous reflectivity (%) does not greatly change even if ultraviolet rays are irradiated, display of a fixed contrast can be carried out in a stabilized state on the basis of the planar voltage Vr and focal conic voltage V′f, which are initially established.

(Experiment 2)

Embodiment 3, Comparative Controls 3 and 4

Using cholesteric liquid crystal that is obtained by blending nematic liquid crystal E-48 by 0.7 grams, which is produced by Merck Corporation, a chiral agent CB-15 at 0.2 grams, which is also produced by Merck Corporation, and another chiral agent CNL-617R at 0.1 grams, which is produced by Asahi Denka Co., Ltd., a reflection type liquid crystal display element shown in FIG. 7 was produced. The surface resistance (sheet resistance) of the transparent electrode 2 is 7Ω per square at both the common side and the segment side, and both of them are patterned to have a width of 100 μm and a length of 80 μm (L/W=800). And the thickness of the liquid crystal layer is 4.5 μm.

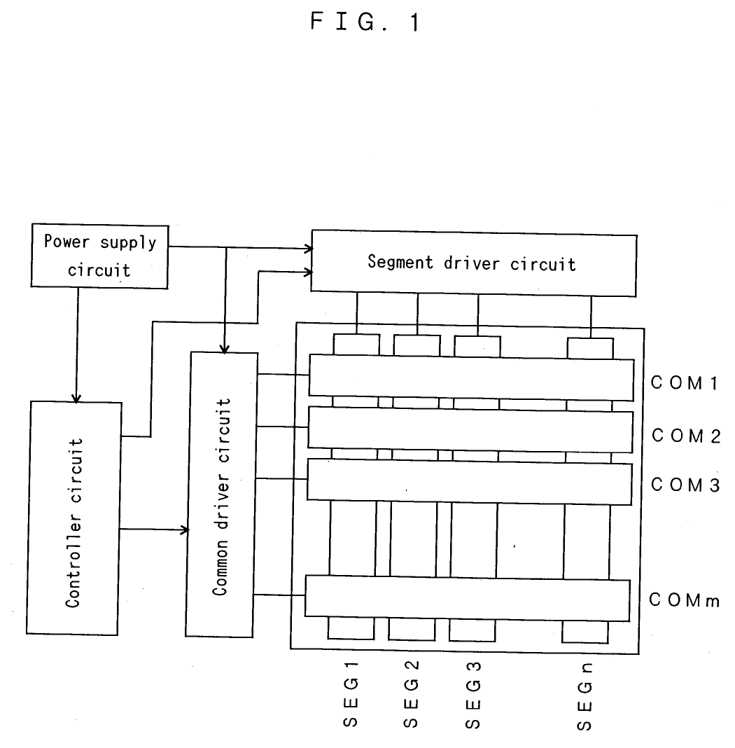

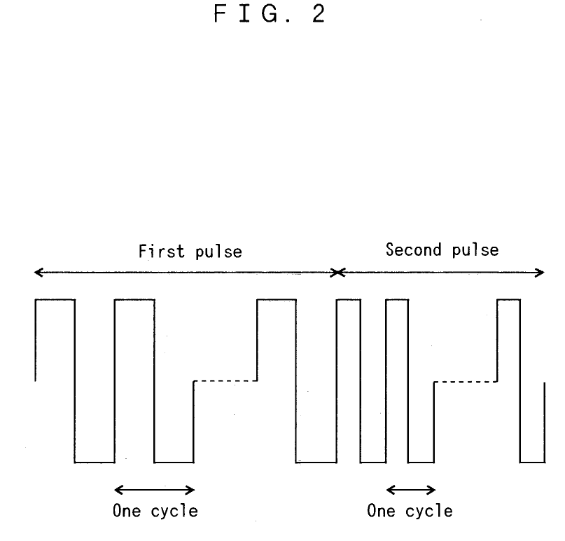

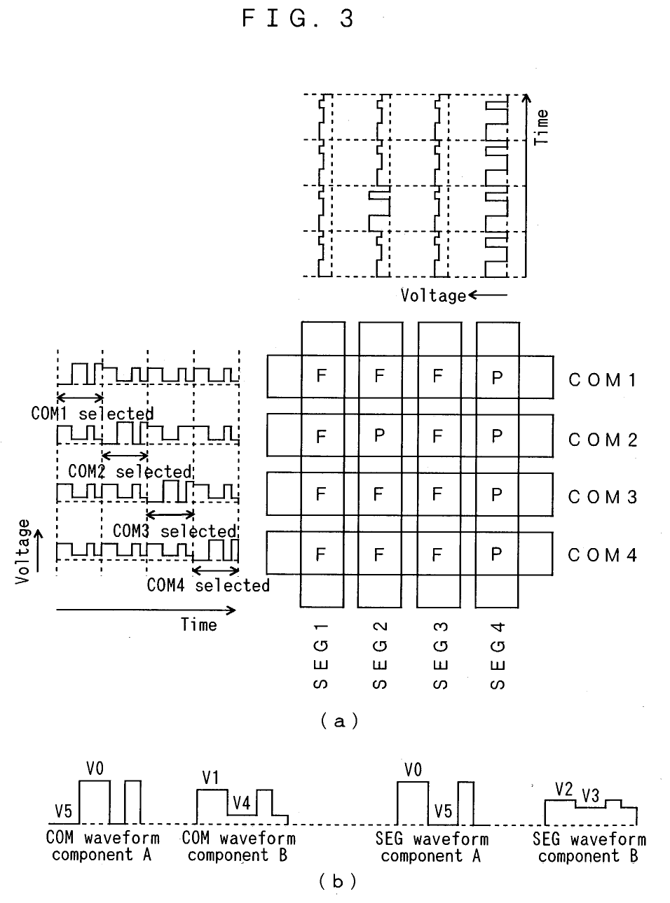

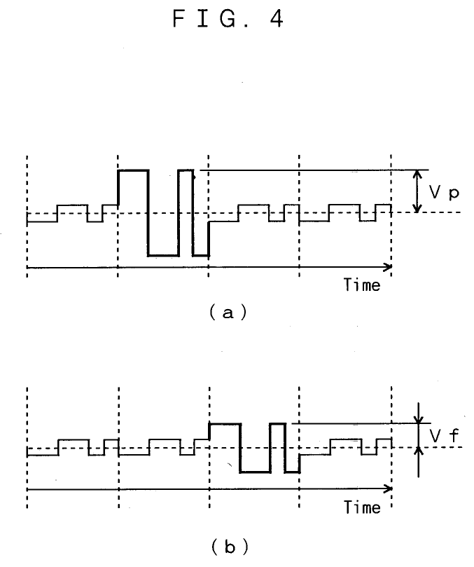

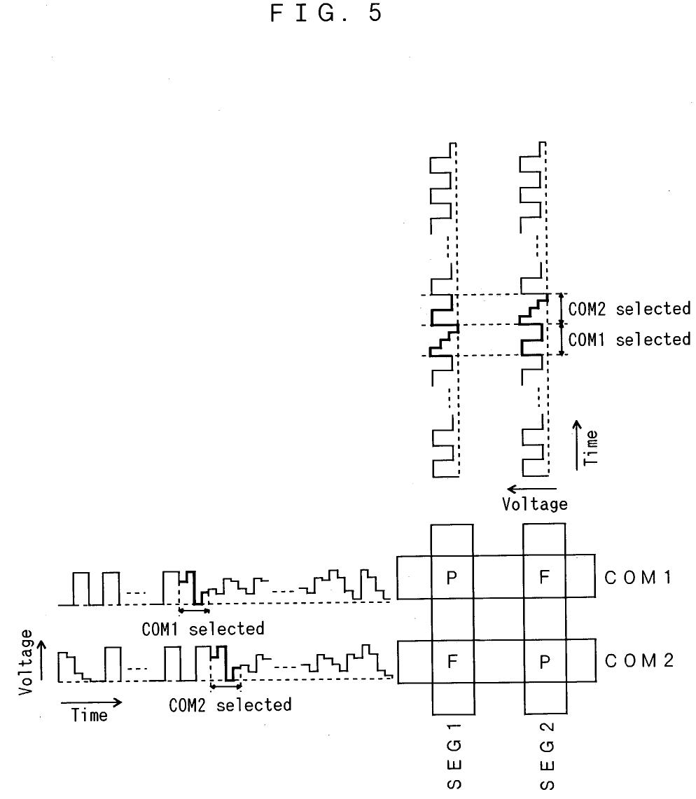

With respect to the obtained panel, the pulse voltage-luminous reflectance characteristics by focal conic resetting before and after irradiation of ultraviolet rays (70 mW/cm², for approx. 20 minutes) were measured to investigate influences due to a difference in the drive pulses. The place of measurement is an area where the end portions of both electrodes (in FIG. 1, pixel area at the right corner far from both the common driver circuit and segment driver circuit) cross each other. Also, the measurement temperature was 25° C.

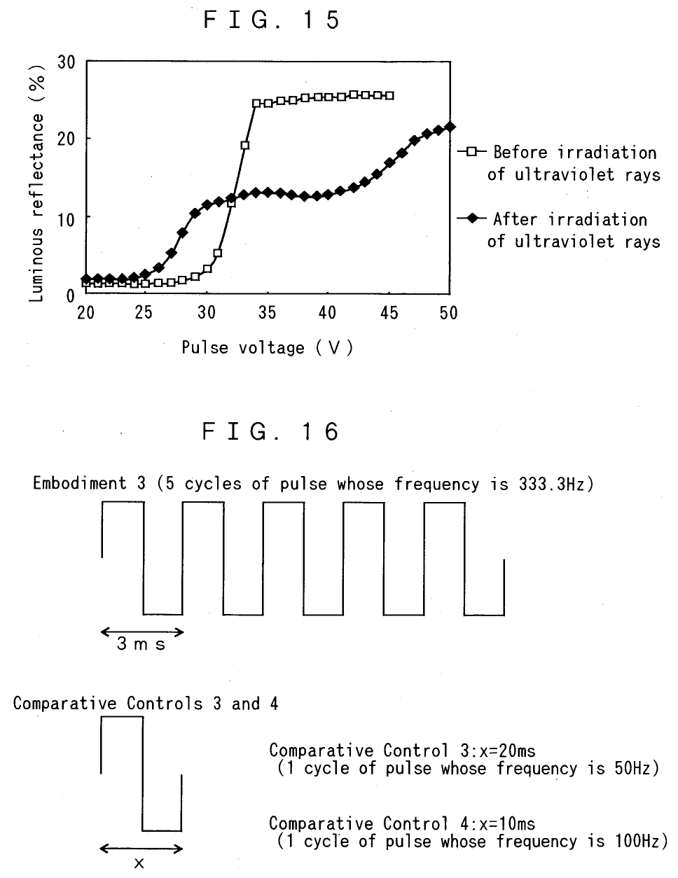

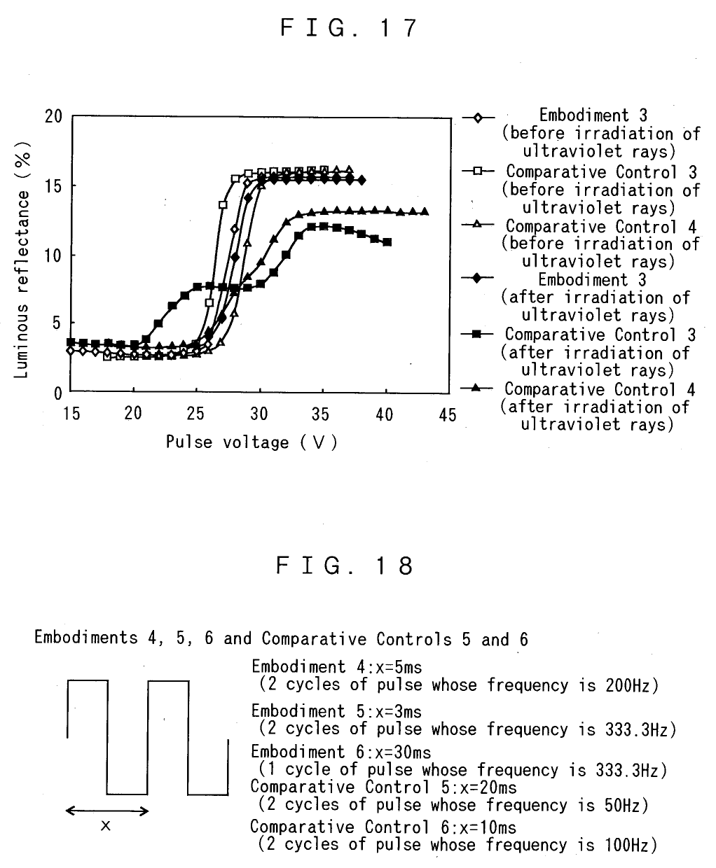

Pulses of Embodiment 3 and Comparative Controls 3 and 4 are shown in FIG. 16. And FIG. 17 shows the result of measurement before and after irradiation of ultraviolet rays.

If the total time of inputted pulses is constant, the pulse voltage-reflectance characteristics collapse due to irradiation of ultraviolet rays in one input of frequencies 50 Hz and 100 Hz. In the pulse application of 333.3 Hz in Embodiment 3, the V-R characteristics scarcely change due to irradiation of ultraviolet rays.

(Experiment 3)

Embodiments 4, 5 and 6, and Comparative Controls 5 and 6

Using cholesteric liquid crystal obtained by adding nematic liquid crystal BDH-BL087 at 0.2 grams to cholesteric liquid crystal MDA-00-3906 at 0.8 grams, which is produced by Merck Corporation, heating and agitating the same, a reflection type liquid crystal display element, whose number of pixels is 300×100, shown in FIG. 7, was produced. The surface resistance (sheet resistance) of the transparent electrode 2 is 15Ω per square at both the common side and the segment side, and both of them are patterned to have a width of 100 μm and a length of 80 mm (L/W=800). And the thickness of the liquid crystal layer is 4.5 μm.

With respect to the obtained panel, the pulse voltage-luminous reflectance characteristics by focal conic resetting before and after irradiation of ultraviolet rays (70 mW/cm², for approx. 20 minutes) were measured to investigate influences due to a difference in the drive pulses. The place of measurement is an area where the end portions of both electrodes cross each other. Also, the measurement temperature was 25° C.

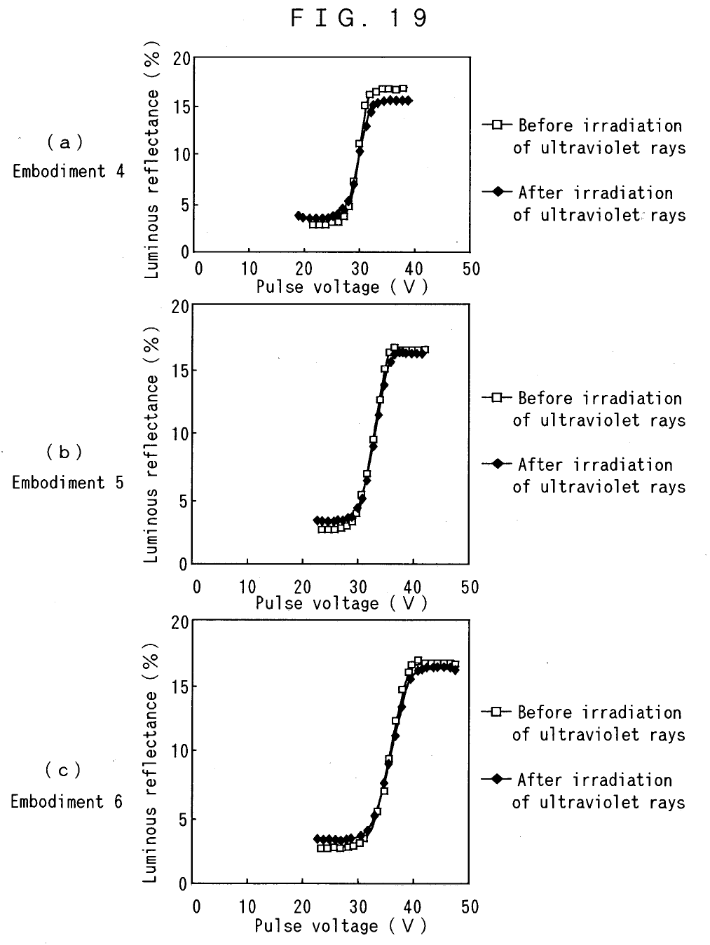

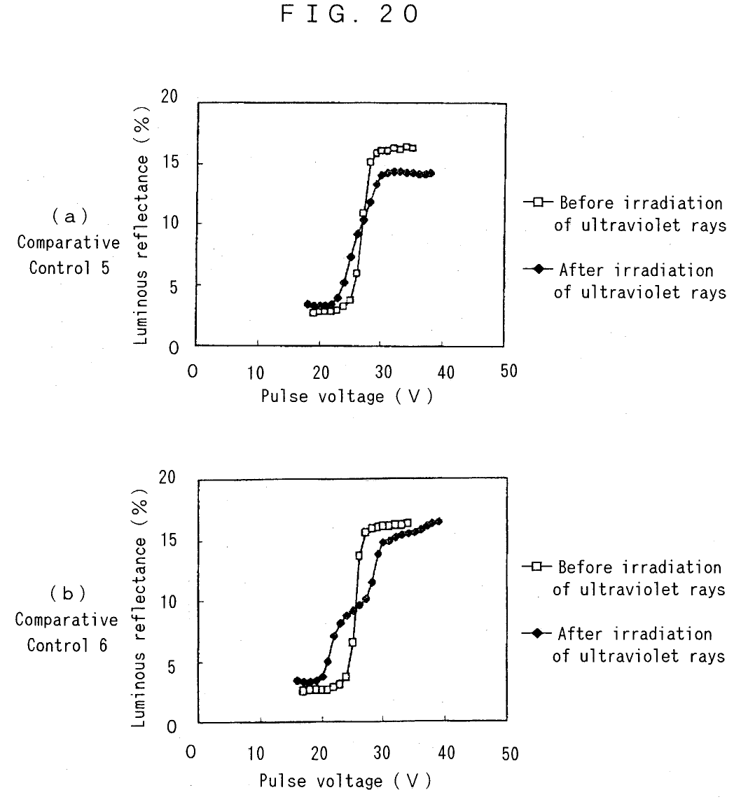

Pulses in Embodiments 4, 5 and 6 are shown in FIG. 18. The results of measurements before and after irradiation of ultraviolet rays are shown in FIG. 19(a), FIG. 19(b) and FIG. 19(c). The results of measurements before and after irradiation of measurements in Comparative Controls 5 and 6 are shown in FIG. 20(a) and FIG. 20(b). Also, FIG. 18 shows pulses in Embodiments 4, 5, and 6 and Comparative Controls 5 and 6.

Based on the results in FIG. 19 and FIG. 20, with respect to samples whose pulse voltage frequencies are 200 Hz and 333.3 Hz, it is found that the V-R characteristics do not change much even if ultraviolet rays are irradiated. To the contrary, with respect to samples of Comparative Controls 5 and 6 which are driven by pulse voltages of 50 Hz and 100 Hz, it is found that the pulse voltage-luminous reflectance characteristics greatly collapse before and after irradiation of ultraviolet rays. Also, if samples of Embodiments 4 and 5 are compared, the Vp start-up voltage is increased in the drive for which the pulse voltage frequency is higher (that is, 333.3 Hz), that is, it is found that the applied voltage to bring about a planar state is increased. Based thereon, a lower frequency of the pulse voltage is preferable in order to make the Vp voltage lower and to secure low voltage drive.

Further, if Embodiment 5 is compared with Embodiment 6, it is found that two-cycle pulse voltage application enables lower voltage drive than in one-cycle pulse voltage application even if the pulse voltage is applied at the same frequency.

(Experiment 4)

Embodiments 7, 8, 9, 10, 11 and 12, Comparative Control 7

A reflection type liquid crystal display element shown in FIG. 7 was produced by the same procedure as that of Embodiment 4 other than using a substrate in which the surface resistance of the transparent electrode 2 is 30Ω per square.

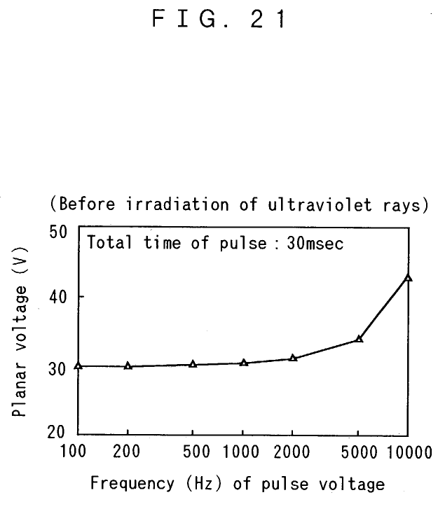

With respect to the above-described liquid crystal display element, influences of the pulse frequency, which exert on the pulse voltage-luminous reflectance characteristics were investigated. One type of pulse is inputted in a plurality of cycles in respective cases, the input time of the pulse is unified to be 30 milliseconds. The measurement is carried out at a temperature of 25° C. Voltage Vp (voltage to change the display to a planar state) is obtained under respective conditions on the basis of the pulse voltage-luminous reflectance curves resulting from the respective obtained focal conic resetting. FIG. 21 is a view showing how the voltage Vp changes, depending on inputted pulse frequencies.

The voltage Vp increases in line with an increase in the frequency of inputted pulse voltages, wherein since an increase in the voltage Vp becomes remarkable between 5,000 Hz and 10,000 Hz, the frequency is determined to be 5,000 Hz or less.

Also, in the case of using two types of pulse voltages, the voltage Vp also increases in line with an increase in the frequency of the input pulse voltage with respect to the second pulse voltage applied in the latter half, and an increase in the voltage Vp becomes remarkable between 5,000 Hz and 10,000 Hz. Therefore, the frequency is determined to be 5,000 Hz or less.

(Experiment 5)

Embodiments 13,14, and 15, and Comparative Control 8

It is investigated how the ratio in which the application time of a pulse voltage of 333.3 Hz employed as one example of a high frequency pulse voltage, of the pulse voltage applied to a pixel to be selected, occupies the selection time influences the luminous reflectance-pulse voltage characteristics of a liquid crystal display element after ultraviolet rays are irradiated.

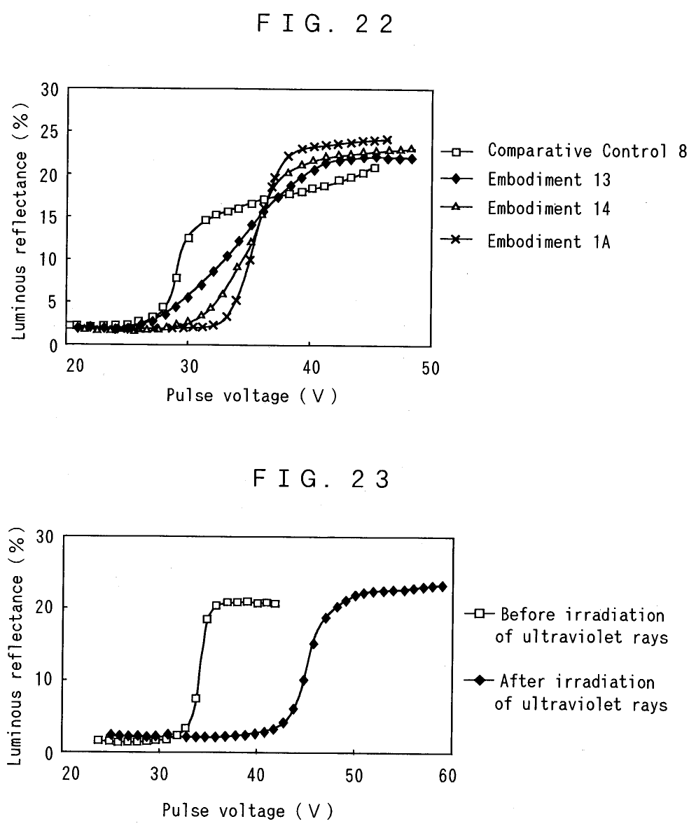

With respect to liquid crystal display elements produced by Embodiments 13, 14, and 15, and Comparative Control 8 in Table 5, the results of having investigated characteristics, after irradiation of ultraviolet rays, of the liquid crystal display elements produced in the same manner as in Embodiment 1 by changing the frequencies and cycles of the drive pulse when carrying out display are shown in FIG. 22 and Table 5 in connection to Embodiments 1A and 2 and Comparative Control 1.

In cases where the ratios at which the high frequency pulse voltage occupies the selection time are 31%, 60%, 80% and 100%, it is recognized that stability of the luminous reflectance-pulse voltage characteristics can be secured with respect to irradiation of ultraviolet rays. Also, of these examples, in comparison with the cases of Embodiments 1A, 14 and 15, the planar voltage becomes higher by 1V in Embodiment 2 of only high frequency drive pulse voltage. Therefore, where the liquid crystal display element is driven by low-voltage drive, it is recognized that Embodiments 1A, 14 and 15 are preferable with respect to the stability against irradiation of ultraviolet rays and a decrease in the drive voltage.

To the contrary, in Comparative Controls 1 and 8, the pixel selection time is 100% with respect to the occupying time made by the pulse voltage of 100 Hz, wherein it is recognized that the above-described characteristics greatly change by irradiation of ultraviolet rays.

Further, a slight change is recognized in the above-described characteristics after irradiation of ultraviolet rays in Embodiment 13, and, it is found that, with respect to the stability against ultraviolet rays, Embodiment 13 is positioned in transition between Embodiment 14 and Comparative Control 1. A change in the characteristics, which is shown in connection with Embodiment 13, is such that drive display of actual liquid crystal display elements can be carried out. Based on the above-described results, it is preferable in view of securing stabilized drive characteristics for irradiation of ultraviolet rays that the time occupied by the high frequency side pulse voltage is 13% or more, more preferably 20% or more, and still more preferably 31% or more.

Embodiment 16

An experiment is carried out in the same manner as those in Embodiment 1, except that the ITO transparent electrode resistance is 100Ω. The measurement waveform is the same as that in FIG. 8.

The V-R characteristics before and after irradiation of ultraviolet rays are shown in FIG. 23. Since the V-R characteristics shift toward the right side in the drawing due to irradiation of ultraviolet rays when the drive voltage Vp is set to 35 through 42V, the liquid crystal cannot be made into a planar state. That is, it is found that the display is not enabled by irradiation of ultraviolet rays.

TABLE 1

| | Segment electrode | | | | Common electrode | | | |
|---|---|---|---|---|---|---|---|---|
| | | | | Surface | | | | Surface |
| | | | | resis- | | | | resis- |
| | Width | Length | L/W | tance | Width | Length | L/W | tance |
| | W (μm) | L (mm) | ratio | Ω/Sq. | W (μm) | L (mm) | ratio | Ω/Sq. |
| (Experiment 1) | | | | | | | | |
| Embodiment | 500 | 50 | 100 | 30 | 500 | 150 | 300 | 30 |
| 1A | | | | | | | | |
| Embodiment | 500 | 50 | 100 | 30 | 500 | 150 | 300 | 30 |
| 1B | | | | | | | | |
| Embodiment 2 | 500 | 50 | 100 | 30 | 500 | 150 | 300 | 30 |
| Comparative | 500 | 50 | 100 | 30 | 500 | 150 | 300 | 30 |
| Control 1 | | | | | | | | |
| Comparative | 500 | 50 | 100 | 30 | 500 | 150 | 300 | 30 |
| Control 2 | | | | | | | | |
| (Experiment 2) | | | | | | | | |
| Embodiment 3 | 100 | 80 | 800 | 7 | 100 | 80 | 800 | 7 |
| Comparative | 100 | 80 | 800 | 7 | 100 | 80 | 800 | 7 |
| Control 3 | | | | | | | | |
| Comparative | 100 | 80 | 800 | 7 | 100 | 80 | 800 | 7 |
| Control 4 | | | | | | | | |
| (Experiment 3) | | | | | | | | |
| Embodiment 4 | 100 | 80 | 800 | 15 | 100 | 80 | 800 | 15 |
| Embodiment 5 | 100 | 80 | 800 | 15 | 100 | 80 | 800 | 15 |
| Embodiment 6 | 100 | 80 | 800 | 15 | 100 | 80 | 800 | 15 |
| Comparative | 100 | 80 | 800 | 15 | 100 | 80 | 800 | 15 |
| Control 5 | | | | | | | | |
| Comparative | 100 | 80 | 800 | 15 | 100 | 80 | 800 | 15 |
| Control 6 | | | | | | | | |

TABLE 2

| | | | | | Common electrode | | | |
|---|---|---|---|---|---|---|---|---|
| | Segment electrode | | | | | | | Segment |
| | Width | Length | L/W | Surface | Width | Length | L/W | resistance |
| | W (μm) | L (mm) | ratio | resistance | W (μm) | L (mm) | ratio | Ω/Sq. |
| (Experiment 4) | | | | | | | | |
| Embodiment 7 | 100 | 80 | 800 | 30 | 100 | 80 | 800 | 30 |
| Embodiment 8 | 100 | 80 | 800 | 30 | 100 | 80 | 800 | 30 |
| Embodiment 9 | 100 | 80 | 800 | 30 | 100 | 80 | 800 | 30 |
| Embodiment 10 | 100 | 80 | 800 | 30 | 100 | 80 | 800 | 30 |
| Embodiment 11 | 100 | 80 | 800 | 30 | 100 | 80 | 800 | 30 |
| Embodiment 12 | 100 | 80 | 800 | 30 | 100 | 80 | 800 | 30 |
| Comparative | 100 | 80 | 800 | 30 | 100 | 80 | 800 | 30 |
| Control 7 | | | | | | | | |
| (Experiment 5) | | | | | | | | |
| Embodiment 13 | 500 | 50 | 100 | 30 | 500 | 150 | 300 | 30 |
| Embodiment 14 | 500 | 50 | 100 | 30 | 500 | 150 | 300 | 30 |
| Embodiment 15 | 500 | 50 | 100 | 30 | 500 | 150 | 300 | 30 |
| Comparative | 500 | 50 | 100 | 30 | 500 | 150 | 300 | 30 |
| Control 8 | | | | | | | | |

TABLE 3

| | | | | Planar | | | |
|---|---|---|---|---|---|---|---|
| | | | | voltage Vp | | | |
| | | | Thickness | before | | | |
| | First pulse | Second pulse | of liquid | irradiation | Irradiation | | |
| | voltage | voltage | crystal | of | of | | |
| | frequency | frequency and | layer | ultra-violet | ultraviolet | | |
| | and cycle | cycle | (μm) | rays | rays | Result views | Contents |
| (Experiment 1) | | | | | | | |
| Embodiment 1A | 100 Hz | 333.3 Hz | 5 | 35 | 70 mW 10 | FIG. 12(a)/ | OK |
| | 2 cycles | 10 cycles | | | minutes | 25° C. | |
| | | | | | (25° C.) | | |
| Embodiment 1B | 100 Hz | 200 Hz | 5 | 35 | Same as | FIG. 12(b)/ | OK |
| | 1 cycle | 8 cycles | | | above | 25° C. | |
| Embodiment 2 | 333.3 Hz 17 | None | 5 | 36 | Same as | | OK |
| | cycles | | | | above | | |
| Comparative | 100 Hz | None | 5 | 35 | Same as | FIG. 14/ | x high pulse |
| Control 1 | 5 cycles | | | above | 25° C. | frequency, | |
| | | | | | | | required |
| Comparative | 333.3 Hz | 100 Hz | 5 | 34 | Same as | FIG. 15/ | x order of first |
| Control 2 | 10 cycles | 2 cycles | | | above | 25° C. | and second pulses |
| (Experiment 2) | | | | | | | |
| Embodiment 3 | 333.3 Hz | | 4.5 | 31 | 70 mW 20 | FIG. 17/ | OK |
| | 5 cycles | | | | minutes (25° | 25° C. | Better to input high |
| | | | | | C.) | | frequency pulses a |
| | | | | | | | plurality of times |
| | | | | | | | than inputting a low |
| | | | | | | | frequency pulse |
| Comparative | 50 Hz | | 4.5 | 29 | Same as | FIG. 17/ | x UV resistance |
| Control 3 | 1 cycle | | | | above | 25° C. | is worse. |
| Comparative | 100 Hz | | 4.5 | 32 | Same as | FIG. 17/ | x UV resistance |
| Control 4 | 1 cycle | | | | above | 25° C. | is worse. |

TABLE 4

| | | | | Planar | | | |
|---|---|---|---|---|---|---|---|
| | | | | voltage Vp | | | |
| | | | | before | | | |
| | | | Thickness | irradia- | Irradiation | | |
| | First pulse | Second pulse | of liquid | tion of | of | | |
| | voltage | voltage | crystal | ultra- | ultra- | | |
| | frequency | frequency and | layer | violet | violet | | |
| | and cycle | cycle | (μm) | rays | rays | Result views | Contents |
| (Experiment 3) | | | | | | | |
| Embodiment 4 | 200 Hz | | 4.5 | 34 | 70 mW 10 | FIG. 19 (a)/ | OK |
| | 2 cycles | | | | minutes | 25° C. | Better that the pulse |
| | | | | | (25° C.) | | frequency is 200 Hz or |
| Embodiment 5 | 333.3 Hz | | 4.5 | 37 | Same as | FIG. 19 (b)/ | more |
| | 2 cycles | | | | above | 25° C. | |
| Embodiment 6 | 333.3 Hz | | 4.5 | 42 | Same as | None | |
| | 1 cycle | | | | above | | |
| Comparative | 50 Hz | | 4.5 | 29 | Same as | FIG. 20 (a)/ | x UV resistance is |
| Control 5 | 2 cycles | | | | above | 25° C. | worse. |
| Comparative | 50 Hz | | 4.5 | 31 | Same as | FIG. 20 (b)/ | x UV resistance is |
| Control 6 | 2 cycles | | | | above | 25° C. | worse. |
| (Experiment 4) | | | | | | | |
| Embodiment 7 | 200 Hz | | 4.5 | 30 | No | FIG. 21/ | Since it is found that |
| | 6 cycles | | | | ultraviolet | 25° C. | V4 radically rises |
| | | | | | ray is | | between 5,000 Hz and |
| | | | | | irradiated | | 10,000 Hz, the second |
| Embodiment 8 | 500 Hz | | 4.5 | 30 | Same as | Same as | pulse of the invention |
| | 15 cycles | | | | above | above | is decided to be |
| Embodiment 9 | 1000 Hz | | 4.5 | 30.5 | Same as | Same as | 5,000 Hz or less. |
| | 30 cycles | | | | above | above | |
| Embodiment 10 | 2000 Hz | | 4.5 | 31 | Same as | Same as | |
| | 60 cycles | | | | above | above | |
| Embodiment 11 | 5000 Hz | | 4.5 | 34 | Same as | Same as | |
| | 150 cycles | | | | above | above | |
| Embodiment 12 | 10000 Hz | | 4.5 | 43 | Same as | Same as | |
| | 300 cycles | | | | above | above | |
| Comparative | 100 Hz | | 4.5 | 30 | Same as | Same as | |
| Control 7 | 3 cycles | | | | above | above | |

TABLE 5

| | | | | | Luminous | | |
|---|---|---|---|---|---|---|---|
| | | | | | reflectance | | |
| | First pulse | Second pulse | | Time ratio | after ultra | | |
| | voltage | voltage | | to which a | violet rays- | | |
| | frequency, | frequency, | | 333.3 Hz | stability of | | |
| | cycle and | cycle and | Total | pulse | pulse voltage | | |
| | selection | selection | selection | voltage | characteris- | Planar | |
| | time | time | time | occupies | tics | voltage | Result views |
| (Experiment 5) | | | | | | | |
| Embodiment 2 | 333.3 Hz | — | 50 | 100% | ∘ (no change | 36 V | |
| | 17 cycles | — | milli-sec- | | before and | | |
| | 50 sec | — | onds | | after | | |
| | | | | | irradiation) | | |
| Embodiment 15 | 100 Hz | 333.3 Hz | 49 | 80% | ∘ (no change | 35 V | |
| | 1 cycle | 13 cycles | milli-sec- | | before and | | |
| | 10 sec | 39 sec | onds | | after | | |
| | | | | | irradiation) | | |
| Embodiment 1A | 100 Hz | 333.3 Hz | 50 | 60% | ∘ (no change | 35 V | |
| | 2 cycles | 10 cycles | milli-sec- | | before and | | |
| | 20 sec | 30 sec | onds | | after | | |
| | | | | | irradiation) | | |
| Embodiment 14 | 100 Hz | 333.3 Hz | 29 | 31% | ∘ (no change | 35 V | |
| | 2 cycles | 3 cycles | milli-sec- | | before and | | |
| | 20 sec | 9 sec | onds | | after | | |
| | | | | | irradiation) | | |
| Embodiment 13 | 100 Hz | 333.3 Hz | 23 | 13% | Δ (A slight | 35 V | |
| | 2 cycles | 1 cycle | milli-sec- | | change rises | | |
| | 20 sec | 3 sec | onds | | before and | | |
| | | | | | after | | |
| | | | | | irradiation) | | |
| Comparative | 100 Hz | — | 50 | 0% | x | 35 V | |
| Control 1 | 5 cycles | — | milli-sec- | | Characteris- | | |
| | 50 sec | — | onds | | tics greatly | | |
| | | | | | changes by | | |
| | | | | | irradiation | | |
| Comparative | 100 Hz | — | 20 | 0% | x | 35 V | |
| Control 8 | 2 cycles | — | milli-sec- | | (Characteris- | | |
| | 20 sec | — | onds | | tics greatly | | |
| | | | | | change by | | |
| | | | | | irradiation) | | |

What is claimed is:

1. A liquid crystal display device for displaying images, which is comprised with
pixel spaces formed, in a matrix form, of a plurality of common electrodes and a plurality of segment electrodes, which are orthogonal to each other,
cholesteric liquid crystal and chiral nematic liquid crystal intervened in said pixel spaces, by applying drive voltage between electrodes between which said pixel spaces are placed,
a driver which apply a pulse voltage whose frequency is 200 Hz or more to said pixels.

2. The liquid crystal display device as set forth in claim 1, wherein the driver applies a pulse voltage whose frequency is 200 Hz or more for two or more cycles.

3. The liquid crystal display device as set forth in claim 1, wherein the driver applies a pulse voltage whose frequency is 333 Hz or more.

4. The liquid crystal display device as set forth in claims 1, wherein the driver applies a pulse voltage whose frequency is 5000 Hz or less.

5. The liquid crystal display device as set forth in claims 1, wherein the driver selects and drives said display pixels for 50 milliseconds or less.

6. The liquid crystal display device as set forth in claims 1, wherein the driver applies said pulse voltage whose frequency of is 333 Hz or more, and have 50 milliseconds or less selection time of said display pixels.

7. The liquid crystal display device as set forth in claims 1, wherein surface resistance of a pair of transparent electrodes constituting said display pixel is 500 per square or less.

8. The liquid crystal display device as set forth in claims 1, wherein the driver applies the pulse voltage at 2V or less at maximum in a difference between display pixels.

9. A liquid crystal display device for displaying images, which is comprised with
pixel spaces formed, in a matrix form, of a plurality of common electrodes and a plurality of segment electrodes, which are orthogonal to each other,
cholesteric liquid crystal and chiral nematic liquid crystal intervened in said pixel spaces, by applying drive voltage between electrodes between which said pixel spaces are placed,
a driver which applies the first pulse voltage and the second pulse voltage continued therefrom, whose frequency is larger than that of the first pulse voltage to said pixels.

10. The liquid crystal display device as set forth in claim 9, wherein the driver applies the first and second pulse voltage whose frequencies are f2 and f2 respectively, wherein f1<200 Hz≦f2 is established.

11. The liquid crystal display device as set forth in claim 9, wherein the driver applies said second pulse voltage whose frequency f2 of is 5,000 Hz or less.

12. The liquid crystal display device as set forth in claims 9, wherein the driver applies said first voltages whose frequency f1 is 10 Hz or more.

13. The liquid crystal display device as set forth in claims 9, wherein the driver applies said second pulse voltage whose frequency is 200 Hz or more for two or more cycles.

14. The liquid crystal display device as set forth in claims 9, wherein the driver applies the second pulse voltage 20% or more in the ratio of time for selecting and driving said display pixels.

15. The liquid crystal display device as set forth in claims 9, wherein the driver applies the second pulse voltage 80% or less in the ratio of time for selecting and driving said display pixels.

16. The liquid crystal display device as set forth in claims 9, wherein the driver selects and drives said display pixels for 50 milliseconds or less.

17. The liquid crystal display device as set forth in claims 9, wherein the surface resistance of a pair of transparent electrodes constituting said display pixel is 500 per square or less.

18. The liquid crystal display device as set forth in claims 9, wherein the driver applies the pulse voltage at 2V or less at maximum in a difference between display pixels.
